(19) United States
(12) Patent Application Publication
(10) Pub. No.: US 2026/0330102 A1
(43) Pub. Date: Oct. 22, 2026

(54) SYSTEM AND METHODS FOR MANUFACTURING FILM

(71) Applicant: NANYA TECHNOLOGY CORPORATION, New Taipei City (TW)

(72) Inventors: Eason TSAI, New Taipei City (TW); Yi-Fang PENG, New Taipei City (TW); Kuan-Sheng WU, New Taipei City (TW)

(21) Appl. No.: 19/183,952

(22) Filed: Apr. 21, 2025

(51) Int. Cl. G06F 30/27; G06F 119/12; G06F 119/18; H01L 21/66

(52) U.S. Cl. CPC G06F 30/27; H10P 74/203; G06F 2119/12; G06F 2119/18

(57) ABSTRACT

A method includes the following operations: collecting data of a tool by a processor; performing machine learning algorithms to analyze the data and a target thickness to generate deposition periods corresponding to the machine learning algorithms by the processor; and selecting a best deposition period from the deposition periods based on coefficients corresponding to the machine learning algorithms by the processor for depositing a film on a wafer based on the best deposition period by the tool, in which the coefficients are associated with relationship between historical deposition periods of the tool and predicted deposition periods corresponding to the machine learning algorithms by the processor.

### BACKGROUND

### Field of Invention

The case relates to a system and methods, and in particular to manufacturing a film.

### Description of Related Art

A recovery procedure of the tool for depositing a film on a wafer is complicated after dry cleaning/wet maintenance, which requires an engineer to manually execute the recovery procedure. The engineer tests the tool to obtain a thickness of the film, and the engineer manually calculates a deposition period and repeats the test until the thickness within a specification range. It takes long time to test the tool once, which is a high cost of time. If the thickness is not able to be within the specification range, it also consumes dummy wafers. Therefore, how to design the recovery procedure to solve the above problems is an important issue in this field.

### SUMMARY

A method includes the following operations: collecting data of a tool by a processor; performing machine learning algorithms to analyze the data and a target thickness to generate deposition periods corresponding to the machine learning algorithms by the processor; and selecting a best deposition period from the deposition periods based on coefficients corresponding to the machine learning algorithms by the processor for depositing a film on a wafer based on the best deposition period by the tool, in which the coefficients are associated with relationship between historical deposition periods of the tool and predicted deposition periods corresponding to the machine learning algorithms by the processor.

In some embodiments, the method further comprises: measuring, by the tool, a current thickness associated with the film; and sending, by the tool, the current thickness to the server.

In some embodiments, the method further comprises: generating, by the processor, a comparison result associated with the current thickness and the target thickness; and in response to the comparison result, collecting, by the processor, the data of the tool.

In some embodiments, the method further comprises: sending, by the tool, a plurality of current thicknesses associated with the film based on the best deposition period to the server composed of the processor; and generating, by the processor, a report associated with a plurality of changes of the plurality of current thicknesses during the best deposition period.

In some embodiments, in which the plurality of coefficients are further associated with a plurality of other historical deposition periods corresponding to a plurality of other tools.

In some embodiments, the method further comprises: displaying, by a user interface of an input/output device, the plurality of deposition periods.

In some embodiments, in which the plurality of machine learning algorithms comprise a linear regression model, a support vector regression model, a kernel nonlinear regression model, a random forest model, a multilayer perceptron model, a voting system model, an ensemble learning model, or a combination thereof.

A method includes the following operations: collecting, by a processor, data of the tool and thicknesses corresponding to the data by the processor; training the machine learning algorithms performed by the processor based on the data and the thicknesses; performing the machine learning algorithms to generate predicted deposition periods by the processor for depositing the film on the wafer based on one of the predicted deposition periods by the tool; and ranking the machine learning algorithms based on coefficients by the processor, in which the coefficients are associated with relationship between historical deposition periods of the tool and the predicted deposition periods.

In some embodiments, the method further comprises: normalizing, by the processor, a plurality of values of the data of the tool between 0 and 1.

In some embodiments, the method further comprises: training, by the processor, the plurality of machine learning algorithms based on the plurality of predicted deposition periods.

In some embodiments, the method further comprises: training, by the processor, the plurality of machine learning algorithms based on other data and a plurality of other thicknesses corresponding to the plurality of other tools.

In some embodiments, the method further comprises: generating, by the processor, the report associated with the plurality of thicknesses and the plurality of predicted deposition periods.

In some embodiments, the method further comprises: displaying, by the user interface of the input/output device, the plurality of predicted deposition periods and the report.

A system includes a tool and the server, in which the server is coupled to the tool. The server includes the processor. The processor collects data of the tool. The processor performs the machine learning algorithms to analyze the data and the target thickness to generate the deposition periods corresponding to the machine learning algorithms. The processor selects the best deposition period from the deposition periods based on coefficients corresponding to the machine learning algorithms, in which the coefficients are associated with relationship between the historical deposition periods of the tool and the predicted deposition periods corresponding to the machine learning algorithms. The tool deposits the film on the wafer to make a current thickness of the film to the target thickness based on the best deposition period.

In some embodiments, in which the processor is further configured to generate the comparison result associated with the current thickness and the target thickness.

In some embodiments, in which the processor is further configured to collect the data of the tool in respond to the comparison result.

In some embodiments, the system further comprises the input/output device configured to display the user interface associated with the plurality of deposition periods.

In some embodiments, in which the input/output device is further configured to receive the comparison result associated with the current thickness and the target thickness from the server, in which the comparison result is generated by the processor.

In some embodiments, the system further comprises: the input/output device configured to display the user interface comprising an interactive button; in which the input/output device sends a control signal to the server for performing the plurality of machine learning algorithms by the processor when the input/output device detects an action result of the interactive button is activated.

In some embodiments, in which the processor is further configured to train the plurality of machine learning algorithms based on the data of the tool and a plurality of historical thicknesses corresponding to the data of the tool.

### BRIEF DESCRIPTION OF THE DRAWINGS

The invention can be more fully understood by reading the following detailed description of the embodiment, with reference made to the accompanying drawings as follows:

FIG. 1 illustrates a block diagram of a system, in accordance with one embodiment of the present disclosure.

FIG. 2A illustrates a flow chart of a method of training machine learning algorithms, in accordance with one embodiment of the present disclosure.

FIG. 2B illustrates a flow chart of a method of performing the machine learning algorithms, in accordance with one embodiment of the present disclosure.

FIG. 3 illustrates a block diagram of the system, in accordance with one embodiment of the present disclosure.

FIG. 4A illustrates a diagram of a user interface provided by an input/output device (for the sake of simplicity, the input/output device is referred to as “the I/O device” below), in accordance with one embodiment of the present disclosure.

FIG. 4B illustrates a diagram of the user interface provided by the I/O device, in accordance with one embodiment of the present disclosure.

FIG. 4C illustrates a diagram of the user interface provided by the I/O device, in accordance with one embodiment of the present disclosure.

FIG. 5 illustrates a chart 500 of the system, in accordance with one embodiment of the present disclosure.

### DETAILED DESCRIPTION

The spirit of the present disclosure will be discussed in the following drawings and detailed description, and those of ordinary skill in the art will be able to change and modify the teachings of the present disclosure without departing from the spirit and scope of the present disclosure.

It should be understood that, in this document and the following claims, when an element is referred to as being “connected” or “coupled” to another element, it can be directly connected or coupled to another element, or there may be an intervening component. In contrast, when an element is referred to as being “directly connected” or “directly coupled” to another element, there is no intervening element. In addition, “electrically connected” or “connected” may also be used to indicate that two or more elements cooperate or interact with each other.

It should be understood that, in this document and the following claims, the terms “include,” “comprise,” “having” and “has/have” are used in an open-ended fashion, and thus should be interpreted to mean “include, but not limited to.”

It should be understood that, in this document and the following claims, the term “and/or” includes any and all combinations of one or more of the associated listed items.

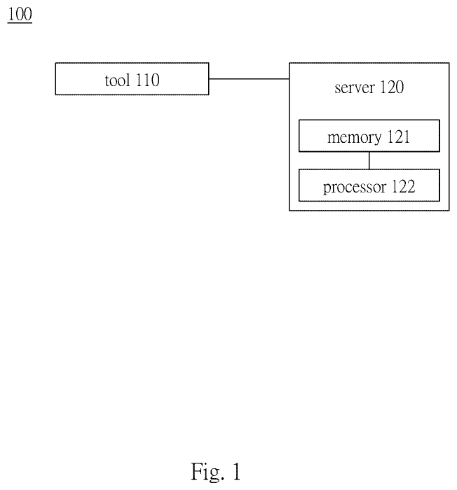

Please refer to FIG. 1. FIG. 1 illustrates a block diagram of a system 100, in accordance with one embodiment of the present disclosure. The system 100 includes a tool 110, a server 120 including a memory 121 and a processor 122. The tool 110 is coupled to the server 120. The memory 121 is coupled to the processor 122.

The tool 110 can be an equipment configured to manufacturing a device on a wafer, for example, by depositing a film on the wafer or performing other manufacturing procedures on wafer.

The server 120 can be a processing device, for example, a computer that provides data storage, processing, and control capabilities to the tool 110, allowing it to operate, monitor process parameters, and collect and analyze data.

The memory 121 can be one or more static random access memory (SRAM) devices, one or more dynamic random access memory (DRAM) devices, one or more flash memory devices, one or more random access memory (RAM) devices, one or more erasable programmable read only memory (EPROM) devices, one or more electrically erasable programmable read only memory (EEPROM) devices, or one or more similar devices.

The processor 122 can be one or more central processing units (CPUs), one or more graphic processing units (GPUs), one or more digital signal processors (DSPs), one or more micro processing units (MPUs), one or more micro control units (MCUs), or one or more similar devices.

In some embodiments, the system 100 is configured to collect data of a tool 110 and perform trained machine learning algorithms to analyze the data of the tool 110 and a target thickness to generate deposition periods corresponding to the machine learning algorithms. For example, the processor 122 performs the trained machine learning algorithm to analyze temperature (e.g., 610° C.) and pressure (e.g., 100 PA) from the tool 110 to generate the deposition period 21.6 seconds.

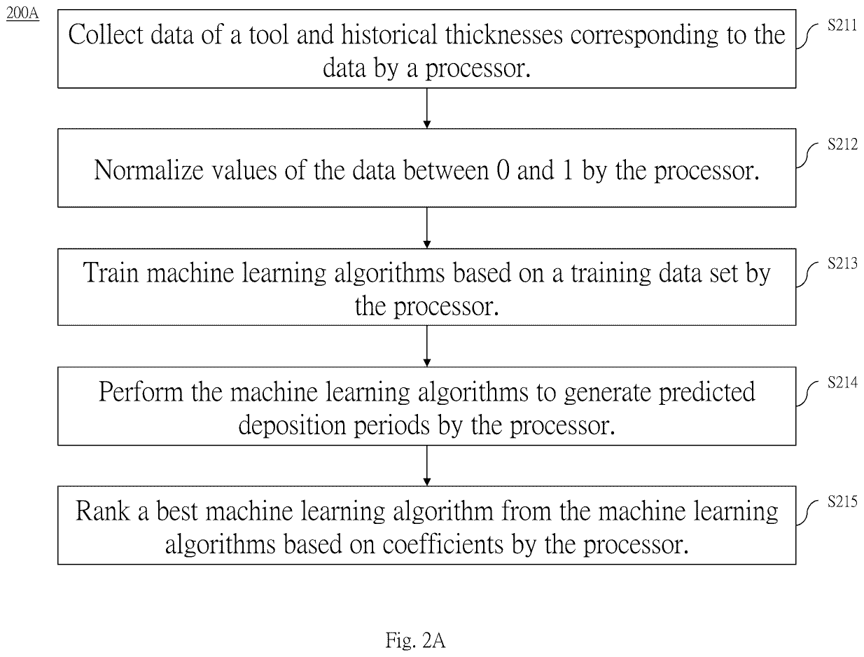

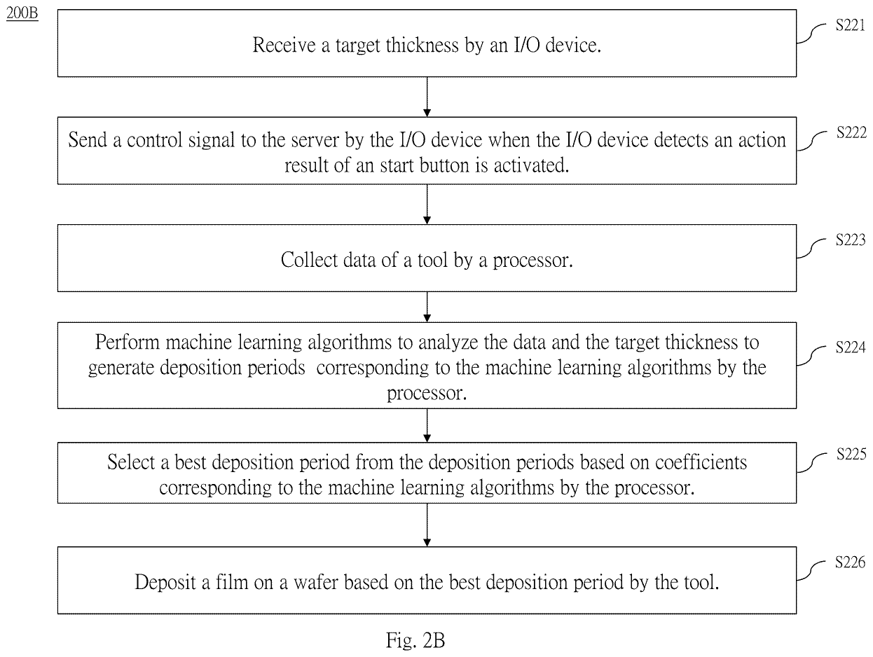

Please refer to FIG. 1 and FIG. 2A. FIG. 2A illustrates a flow chart of a method 200A of training the machine learning algorithms, in accordance with one embodiment of the present disclosure. In some embodiments, the method 200A can be implemented in the server 120.

At operation S211, the processor 122 collects the (setting) data of the tool 110 and historical thicknesses corresponding to the data of the tool 110. In some embodiments, the tool 110 previously deposited a film to one of the historical thicknesses based on corresponding setting data of the tool. The data includes at least one of historical temperatures, historical pressures, historical voltages, historical deposition periods, historical radio frequency powers, or similar data associated with depositing the film on the wafer by the tool 110 before.

At the operation S212, the processor 122 extracts and transforms the historical data (e.g. principal component analysis method) to orthogonal form for more efficient model training use, then normalizes the values by scaling the data into a range between 0 and 1 or by using similar methods.

For example, after the processor 122 collects the historical temperatures (e.g., 610° C., 620° C., 630° C, etc.), the historical deposition periods (e.g., 61 seconds, 62 seconds, 63 seconds, etc.), and the historical thicknesses (e.g., 66 Å, 67 Å, 68 Å, etc.) from the tool 110, the processor 122 performs a code stored in the memory 121 to scale the historical temperatures (by scaling, the values of the historical temperatures are transformed to 0.61° C., 0.62° C., 0.63° C., etc.), the historical deposition periods (by scaling, the values of the historical deposition periods are transformed to 0.61 seconds, 0.62 seconds, 0.63 seconds, etc.), and the historical thicknesses (by scaling, the values of the historical thicknesses are transformed to 0.66 Å, 0.67 Å, 0.68 Å, etc.).

At operation S213, the processor 122 trains machine learning algorithms based on a training data set including 80% of the historical data (e.g., the historical temperatures, the historical thicknesses, and the historical deposition periods, etc.). 20% of the historical data are utilized as a testing data set to evaluate performance of the trained machine learning algorithms.

For example, the machine learning algorithm learns the relationship between the historical temperatures (e.g., 0.61° C., 0.62° C., 0.63° C., etc.), the historical thicknesses (e.g., 0.66 Å, 0.67 Å, 0.68 Å, etc.), and the historical deposition periods (e.g., 0.61 seconds, 0.62 seconds, 0.63 seconds, etc.) to adjust parameters of the machine learning algorithm. After learning, the testing data set are utilized to evaluate the performance of the trained machine learning algorithm. Specifically, the trained machine learning algorithm generate the predicted deposition periods (e.g., 0.64 seconds, 0.65 seconds, 0.66 seconds, etc.) based on the historical temperatures (e.g., 0.64° C., 0.65° C., 0.66° C., etc.) and the historical thicknesses (e.g., 0.69 Å, 0.70 Å, 0.71 Å, etc.) from the testing data set. The processor 122 compares the predicted deposition periods and the corresponding historical deposition periods (e.g., 0.64 seconds, 0.63 seconds, 0.66 seconds, etc.) from the testing set. The operation S213 stops when the accuracy of the machine learning algorithm is met an ideal ratio. Taking the ideal ratio of 75% as example, when the accuracy is lower than 75%, the processor 122 performs the operation S213 again. When the accuracy is higher than the ideal ratio, the processor 122 stops the operation S213.

In some embodiments, the machine learning algorithms includes at least one of a linear regression model, a support vector regression model, a kernel nonlinear regression model, a random forest model, a multilayer perceptron model, or similar models.

In some embodiments, the data for training machine learning algorithms is without pre-procession (normalization) by the processor 122.

At operation S214, the processor 122 performs the machine learning algorithms to generate predicted deposition periods.

For example, the processor 122 performs the linear regression model, the support vector regression model, the kernel nonlinear regression model, the random forest model, and the multilayer perceptron model separately based on the historical temperatures (e.g., 0.61° C., 0.62° C., 0.63° C., 0.64° C., 0.65° C., etc.) and the historical thicknesses (e.g., 0.66 Å, 0.67 Å, 0.68 Å, 0.69 Å, 0.70 Å, etc.) to generate the predicted deposition periods 21.6 seconds, 21.4 seconds, 22.5 seconds, 22.3 seconds, and 21.7 seconds.

At operation S215, the processor 122 ranks a best machine learning algorithm from the machine learning algorithms based on coefficients.

In some embodiments, the coefficients are correlation coefficients. The correlation coefficients present correlations between the historical deposition periods and the predicted deposition periods generated by the machine learning algorithms. The higher the correlation coefficients are, the higher the correlations are. The machine learning algorithms with the higher correlation coefficients are ranked higher.

For example, the processor 122 analyzes the predicted deposition periods and the historical deposition periods by a method of linear regression to generate the correlation coefficients corresponding to the models mentioned above. For example, the historical deposition periods of the linear regression model are 20.6 seconds, 20.4 seconds, 21.5 seconds, etc., and the predicted deposition periods of the linear regression model are 21.5 seconds, 21.3 seconds, 22.4 seconds, etc., so a correlation coefficient of the linear regression model is 0.75. The historical deposition periods of the random forest model are 21.6 seconds, 21.4 seconds, 22.5 seconds, etc., and the predicted deposition periods of the random forest model are 21.5 seconds, 21.3 seconds, 22.4 seconds, etc., so a correlation coefficient of random forest model is 0.83. Therefore, the processor 122 ranks the random forest model as No. 1 and the linear regression model as No. 2.

In some embodiments, the processor 122 analyzes not only the predicted deposition periods and the historical deposition periods of the tool 110 but also other historical deposition periods corresponding to other tools by the method of linear regression to generate the coefficients corresponding to the models mentioned above.

In some embodiments, at least one of the operations S212 and S215 can be omitted.

In some embodiments, the processor 122 trains the machine learning algorithms not only based on the data and the historical thicknesses of the tool 110 but also based on other data and other historical thicknesses corresponding to other tools.

In some embodiments, the machine learning algorithms trained by the processor 122 only based on the data and the historical thicknesses of the tool 110 are referred to as “single machine learning algorithm”. The machine learning algorithms trained by the processor 122 using the data and the historical thicknesses of the tool 110 plus the other data and the other historical thicknesses corresponding to the other tools are referred to as “common machine learning algorithm”.

In some embodiments, the processor 122 trains second stage models(e.g., a voting system model, an ensemble learning model, or the similar models) by inputting the basic models' (e.g., the linear regression model, the support vector regression model, the kernel nonlinear regression model, the random forest model, the multilayer perceptron model, or the similar models) outputs (e.g., the predicted deposition periods generated by the basic models').

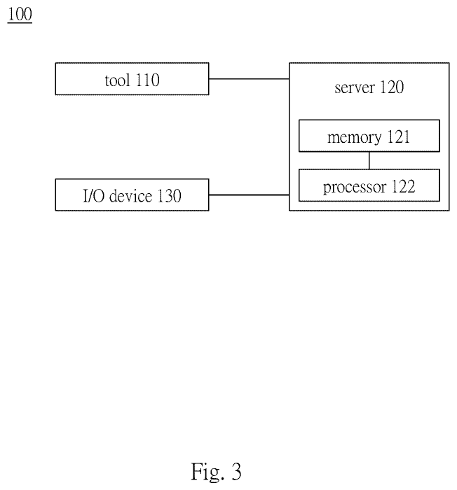

Please refer to FIG. 1, FIG. 2B, and FIG. 3. FIG. 2B illustrates a flow chart of a method 200B of performing the machine learning algorithms to analyze the data and the target thickness to generate deposition periods corresponding to the machine learning algorithms for depositing the film on the wafer based on one of the deposition periods by the tool 110, in accordance with one embodiment of the present disclosure. In some embodiments, the method 200B can be implemented in the server 120.

FIG. 3 illustrates a block diagram of the system 100, in accordance with one embodiment of the present disclosure. Comparing to the system 100 in FIG. 1, a system 100 in FIG. 3 further includes an input/output device 130 (for the sake of simplicity, the input/output device 130 is referred to as “the I/O device 130” below), in which the I/O device 130 is coupled to the server 120.

The I/O device 130 can be a personal computer, a laptop, and a mobile device (such as a cell phone or a tablet), or a similar electronic device with one of a monitor, a touch display panel, or a similar display device.

In some embodiments, the I/O device 130 provides a user interface 400 and receives a target thickness.

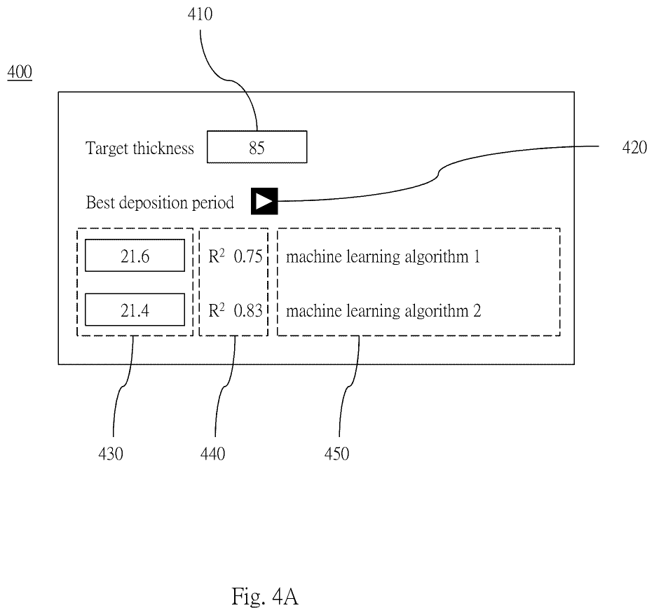

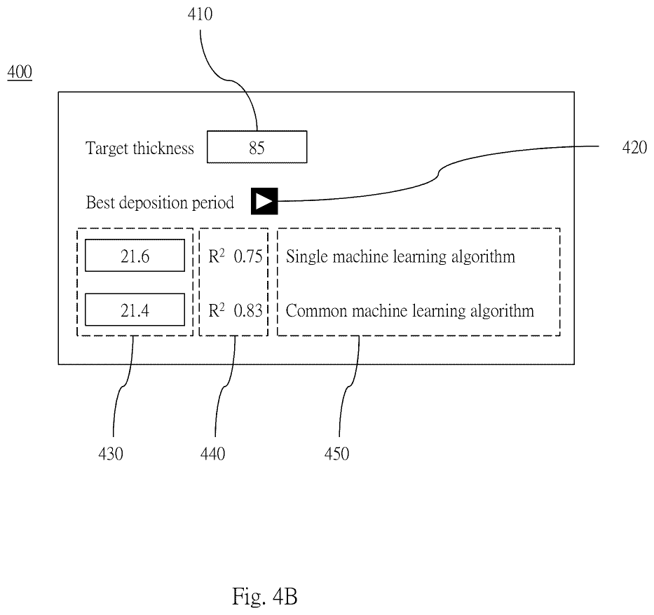

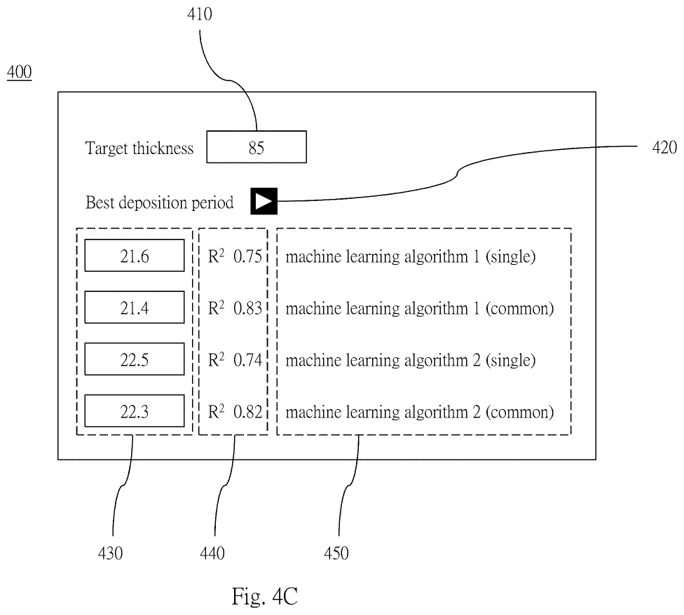

Please refer to FIG. 3, FIG. 2B, and FIG. 4A. FIG. 4A illustrates a diagram of the user interface 400 provided by the I/O device 130, in accordance with one embodiment of the present disclosure.

At operation S221, the I/O device 130 receives the target thickness by the user interface 400 in FIG. 4A.

In some embodiments, the user interface 400 includes a target thickness setting area 410, a start button 420, a deposition period display area 430, a coefficient display area 440, and a machine learning algorithm type display area 450.

For example, the I/O device 130 receives the target thickness (e.g., 85 Å), which is inputted by a user in the target thickness setting area 410, according to some embodiments.

At operation S222, the I/O device 130 sends a control signal to the server 120 when the I/O device 130 detects an action result of the start button 420 being activated.

For example, by the user clicking the start button 420, the I/O device 130 detects that the action result of the start button 420 is activated, so the I/O device 130 sends the control signal to the server 120. In some embodiments, the control signal is associated with the target thickness (e.g., 85 Å).

At operation S223, in response to the control signal, the processor 122 collects the data of the tool 110. The data includes at least one of a current temperature, a current pressure, a current voltage, a current radio frequency powers, or similar data of the tool 110 in a current condition.

For example, in response to the control signal, the processor 122 collects the current temperature (e.g., 610° C.) and the current pressure (e.g., 100 PA) from the tool 110.

At operation S224, the processor 122 performs the machine learning algorithms on the data of the tool 110 and the target thickness from the user interface 400 to generate deposition periods corresponding to the machine learning algorithms.

For example, the processor 122 performs the linear regression model and the random forest model according to the data of the tool 110 and the target thickness to generate the deposition periods 21.6 seconds and 21.4 seconds respectively.

In some embodiments, as shown in FIG. 4A, the I/O device 130 receives the deposition periods, the coefficients, and names of the machine learning algorithms from the server 120, and the deposition period display area 430 of the I/O device 130 displays the deposition periods. The coefficients, for example, as mentioned with reference to the operation S215 are displayed in the coefficient display area 440 by the I/O device 130. The names of the machine learning algorithms, e.g., “Linear regression model” and “Random forest model” (referred to as “Machine learning algorithm 1” and “Machine learning algorithm 1” respectively in FIG. 4A), are displayed in the machine learning algorithm type display area 450 by the I/O device 130.

In some embodiments, the predicted deposition periods are displayed in the deposition period display area 430 by the I/O device 130.

Please refer to FIG. 4B. FIG. 4B illustrates a diagram of the user interface 400 provided by the I/O device 130, in accordance with one embodiment of the present disclosure. In some embodiments, the I/O device 130 displays the deposition periods, the coefficients, and machine learning algorithms types that show machine learning algorithms are of the same model and trained based on different data sets.

For example, the processor 122 trains linear regression model based on the data and the historical thicknesses of the tool 110 and further based on the other data and the other historical thicknesses corresponding to the other tools, so there are 2 types of linear regression models (e.g., “Single machine learning algorithm” and “Common machine learning algorithm”) that can be performed by the processor 122 to generate the deposition periods 21.6 seconds and 21.4 seconds respectively, as shown in the deposition period display area 430 by the I/O device 130 of FIG. 4B. The coefficients corresponding to the single machine learning algorithm and the common machine learning algorithm are displayed in the coefficient display area 440 by the I/O device 130. The types of the machine learning algorithms, e.g., “Single machine learning algorithm” and “Common machine learning algorithm”, are displayed in the machine learning algorithm type display area 450 by the I/O device 130.

Please refer to FIG. 4C. FIG. 4C illustrates a diagram of the user interface 400 provided by the I/O device 130, in accordance with one embodiment of the present disclosure. In some embodiments, the I/O device 130 displays the deposition periods, the coefficients, and machine learning algorithms types based on the machine learning algorithms, in which each of the machine learning algorithms trained by different data respectively.

For example, the processor 122 trains linear regression model (referred to as “Machine learning algorithm 1” in FIG. 4C) and the random forest model (referred to as “Machine learning algorithm 2” in FIG. 4C) based on the data and the historical thicknesses of the tool 110 and further based on the other data and the other historical thicknesses corresponding to the other tools, so there are 4 types of linear regression models (e.g., “Machine learning algorithm 1 (single)”, “Machine learning algorithm 1 (common)”, “Machine learning algorithm 2 (single)”, and “Machine learning algorithm 2 (common)”) that can be performed by the processor 122 to generate the deposition periods 21.6 seconds, 21.4 seconds, 22.5 seconds, and 22.3 seconds respectively. The I/O device 130 displays the deposition periods in the deposition period display area 430. The coefficients corresponding to the single machine learning algorithm and the common machine learning algorithm are displayed in the coefficient display area 440 by the I/O device 130. The types of the machine learning algorithms, e.g., “Machine learning algorithm 1 (single)”, “Machine learning algorithm 1 (common)”, “Machine learning algorithm 2 (single)”, and “Machine learning algorithm 2 (common)”, are displayed in the machine learning algorithm type display area 450 by the I/O device 130.

In some embodiments, the I/O device 130 displays one deposition period or more than two deposition periods on the user interface 400.

At operation S225, the processor 122 selects a best deposition period from the deposition periods based on the coefficients corresponding to the machine learning algorithms, in which the coefficients are mentioned at the operation S215.

For example, the processor 122 performs the linear regression model and the random forest model to generate the deposition periods 21.6 seconds and 21.4 seconds respectively, and the coefficients of the linear regression model and the random forest model mentioned at the operation S215 are 0.75 and 0.83 respectively. Therefore, the processor 122 performs the code stored in the memory 121 to select the deposition period of the random forest model as the best deposition period because the coefficient of the random forest model is greater than the coefficient of the linear regression model.

At operation S226, the tool 110 deposits the film on the wafer based on the best deposition period.

For example, the server 120 sends a signal associated with the best deposition period (e.g. 21.4 seconds) to the tool 110, and the tool 110 deposits the film on the wafer for 21.4 seconds in response to the signal.

In some embodiments, at least one of the operations S222, S225, and S226 can be omitted.

In some embodiments, the tool 110 measures a current thickness of the film after the operation S226, and sends the current thickness to the server 120 for determining whether the current thickness equals to the target thickness.

In some embodiments, the processor 122 generates a comparison result of the current thickness and the target thickness. When the comparison result is that the current thickness is not equal to the target thickness, the operations S223 to S226 are performed until the current thickness equals to the target thickness. The data includes at least one of the current temperature, the current pressure, the current voltage, the current radio frequency powers, or the similar data associated with the current condition of the tool 110.

For example, the current thickness measured by the tool 110 is 85 Å and the target thickness is 84 Å, so the comparison result generated by the processor 122 are that the current thickness doesn't equal to the target thickness. The processor 122 performs the operation S223 to collect the data of the tool 110. The data of the tool 110 is different from the data of the tool 110 collected before because the current condition of the tool 110 is different after the tool 110 deposits the film on the wafer. After the operation S223, the processor 122 performs the rest of the operations (the operations S224 to S226).

In some embodiments, the I/O device 130 receives the comparison result mentioned above from the server 120 after the operation S226. For example, the I/O device 130 receives an email having a content of the current thickness not equal to the target thickness from the tool 110.

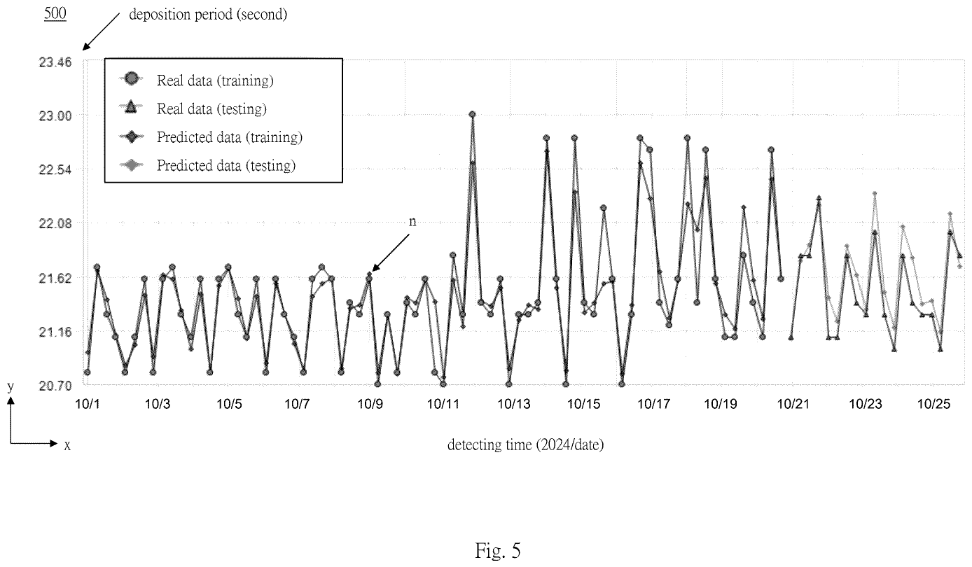

Please refer to FIG. 5. FIG. 5 illustrates a chart 500 of the system 100, in accordance with one embodiment of the present disclosure. In some embodiments, the I/O device 130 displays the chart 500 associated with the historical deposition periods and the predicted deposition periods on the user interface 400, in which the I/O device 130 receives the historical deposition periods and the predicted deposition periods from the server 120. An x-axis represents detecting time when the tool 110 detects a value of the deposition period of itself at the detecting time. A y-axis represents the value of the deposition period.

In some embodiments, a unit of the x-axis is date, and a unit of the y-axis is the seconds. Taking a point n for example, the point n represents that the tool 110 deposited the film on the wafer for 21.62 seconds on Oct. 9, 2024.

In some embodiments, “Predicted data (training)” represents the predicted deposition periods generated by the machine learning algorithms during the processor 122 training the machine learning algorithms. “Real data (training)” represents the historical deposition periods used to training the machine learning algorithms. “Predicted data (testing)” represents the predicted deposition periods generated by the machine learning algorithms after the processor 122 training the machine learning algorithms. “Real data (testing)” represents the historical deposition periods not used to training the machine learning algorithms.

In some embodiments, the tool 110 sends current thicknesses associated with the film based on the best deposition period to the server 120. The processor 122 generates a report associated with changes of the current thicknesses during the best deposition period.

For example, the current thickness after the tool 110 depositing the film on the wafer is 85 Å, and the best deposition period is 21.4 seconds. Therefore, the report has a chart associated with changes of the current thicknesses during the best deposition period, e.g., the current thickness is 5 Å at 3 seconds, and the current thickness is 10 Å at 10 seconds.

In some embodiments, the processor 122 generates a report associated with the historical thicknesses and the predicted deposition periods.

For example, a report has a chart associated with the predicted deposition periods corresponding to the historical thickness, e.g., the historical thickness is 85 Å when the predicted deposition is 21.4 seconds, and the historical thickness is 75 Å when the predicted deposition is 19.5 seconds.

In some embodiments, the data, the target thickness, the historical thickness, the current thickness, the deposition periods, the historical deposition periods, the predicted deposition periods, and the coefficients are stored in the memory 121.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method, comprising:
collecting, by a processor, data of a tool;
performing, by the processor, a plurality of machine learning algorithms to analyze the data of the tool and a target thickness to generate a plurality of deposition periods corresponding to the plurality of machine learning algorithms; and
selecting, by the processor, a best deposition period from the plurality of deposition periods based on a plurality of coefficients corresponding to the plurality of machine learning algorithms for depositing a film on a wafer based on the best deposition period by the tool, wherein the plurality of coefficients are associated with relationship between a plurality of historical deposition periods of the tool and a plurality of predicted deposition periods corresponding to the plurality of machine learning algorithms by the processor.

2. The method of claim 1, further comprising:
measuring, by the tool, a current thickness associated with the film; and
sending, by the tool, the current thickness to a server.

3. The method of claim 2, further comprising:
generating, by the processor, a comparison result associated with the current thickness and the target thickness; and
in response to the comparison result, collecting, by the processor, the data of the tool.

4. The method of claim 1, further comprising:
sending, by the tool, a plurality of current thicknesses associated with the film based on the best deposition period to a server composed of the processor; and
generating, by the processor, a report associated with a plurality of changes of the plurality of current thicknesses during the best deposition period.

5. The method of claim 1, wherein the plurality of coefficients are further associated with a plurality of other historical deposition periods corresponding to a plurality of other tools.

6. The method of claim 1, further comprising:
displaying, by a user interface of an input/output device, the plurality of deposition periods.

7. The method of claim 1, wherein the plurality of machine learning algorithms comprise a linear regression model, a support vector regression model, a kernel nonlinear regression model, a random forest model, a multilayer perceptron model, a voting system model, an ensemble learning model, or a combination thereof.

8. A method, comprising:
collecting, by a processor, data of a tool and a plurality of thicknesses corresponding to the data of the tool;
training a plurality of machine learning algorithms performed by the processor based on the data of the tool and the plurality of thicknesses;
performing, by the processor, the plurality of machine learning algorithms to generate a plurality of predicted deposition periods for depositing a film on a wafer based on one of the plurality of predicted deposition periods by the tool; and
ranking, by the processor, the plurality of machine learning algorithms based on a plurality of coefficients, wherein the plurality of coefficients are associated with relationship between a plurality of historical deposition periods of the tool and the plurality of predicted deposition periods.

9. The method of claim 8, further comprising:
normalizing, by the processor, a plurality of values of the data of the tool between 0 and 1.

10. The method of claim 8, further comprising:
training, by the processor, the plurality of machine learning algorithms based on the plurality of predicted deposition periods.

11. The method of claim 8, further comprising:
training, by the processor, the plurality of machine learning algorithms based on other data and a plurality of other thicknesses corresponding to a plurality of other tools.

12. The method of claim 8, further comprising:
generating, by the processor, a report associated with the plurality of thicknesses and the plurality of predicted deposition periods.

13. The method of claim 12, further comprising:
displaying, by a user interface of an input/output device, the plurality of predicted deposition periods and the report.

14. A system, comprising:
a tool; and
a server coupled to the tool, comprising:
a processor configured to:
collect data of the tool;
perform a plurality of machine learning algorithms to analyze the data of the tool and a target thickness to generate a plurality of deposition periods corresponding to the plurality of machine learning algorithms; and
select a best deposition period from the plurality of deposition periods based on a plurality of coefficients corresponding to the plurality of machine learning algorithms, wherein the plurality of coefficients are associated with relationship between a plurality of historical deposition periods of the tool and a plurality of predicted deposition periods corresponding to the plurality of machine learning algorithms;
wherein the tool deposits a film on a wafer to make a current thickness of the film to the target thickness based on the best deposition period.

15. The system of claim 14, wherein the processor is further configured to generate a comparison result associated with the current thickness and the target thickness.

16. The system of claim 15, wherein the processor is further configured to collect the data of the tool in respond to the comparison result.

17. The system of claim 14, further comprising:
an input/output device configured to display a user interface associated with the plurality of deposition periods.

18. The system of claim 17, wherein the input/output device is further configured to receive a comparison result associated with the current thickness and the target thickness from the server, wherein the comparison result is generated by the processor.

19. The system of claim 14, further comprising:
an input/output device configured to display a user interface comprising an interactive button;
wherein the input/output device sends a control signal to the server for performing the plurality of machine learning algorithms by the processor when the input/output device detects an action result of the interactive button is activated.

20. The system of claim 14, wherein the processor is further configured to train the plurality of machine learning algorithms based on the data of the tool and a plurality of historical thicknesses corresponding to the data of the tool.
